(19) United States
(12) Patent Application Publication
(10) Pub. No.: US 2010/0301510 A1
(43) Pub. Date: Dec. 2, 2010

(54) METHOD OF REDUCING FILM DENSITY AND RELATED PRODUCT

(76) Inventor: Theodore R. Coburn, Coventry, RI (US)

Correspondence Address: CHRIS A. CASEIRO, VERRILL DANA, LLP, ONE PORTLAND SQUARE, PORTLAND, ME, 04112-0586, US

(21) Appl. No.: 12/853,869

(22) Filed: Aug. 10, 2010

Related U.S. Application Data
(63) Continuation-in-part of application No. 12/053,303, filed on Mar. 21, 2008, now abandoned.
(60) Provisional application No. 60/896,409, filed on Mar. 22, 2007.

(51) Int. Cl. B32B 3/26; B29C 47/06

(52) U.S. Cl. 264/45.1; 428/315.5; 428/315.9; 264/241

(57) ABSTRACT

A microvoided film formed by mixing a microvoid forming additive with a composition including a polymeric material. The microvoided film includes a printability additive. The microvoids formed during the processing of the composition to convert it into a film result in a reduction of the density of the film, making a lighter weight film requiring less polymeric material to produce a film of desired thickness while maintaining suitable structural characteristics than required when making a higher density film. The microvoids are formed through β crystallization of the polymeric material during casting and in a later cold drawing stage of the orientation portion of the film fabrication process. The microvoided film may be fabricated to be opaque with or without pigment additive included in the composition. The film may multilayered. In one embodiment, the multilayered film is three-layered including a core without printability additive and two outer layers with the printability additive. The three-layer film has a density of less than about 0.7 g/cc.

### CROSS REFERENCE TO RELATED APPLICATION

The present application is a continuation-in-part of, and claims the priority benefit in, U.S. patent application Ser. No. 12/053,303, filed Mar. 21, 2008, entitled “METHOD OF REDUCING FILM DENSITY AND RELATED PRODUCT”, of the same named inventor and which application claims the priority benefit of U.S. provisional patent application Ser. No. 60/896,409, filed Mar. 22, 2007, entitled “A METHOD OF REDUCING FILM DENSITY AND RELATED PRODUCT” of the same named inventor. The entire contents of these prior applications are incorporated herein by reference.

### BACKGROUND OF THE INVENTION

1. Field of the Invention

The present invention relates to films or sheets used for a wide variety of purposes. Such films or sheets are hereinafter referred to as “film” or “films.” More particularly, the present invention relates to films fabricated of polymeric materials processed to reduce original material density while maintaining desirable characteristics such as printability, for example. The present invention is directed to a single layer film exhibiting substantial reduction in density in comparison to predecessors without substantially diminishing other desired characteristics. The film of the present invention may also form part of a multilayer extrusion.

2. Description of the Prior Art

Polymer-based films may be used for a wide array of purposes, from coatings to labels to tags and so forth. Polymer-based films have found many applications because they have a desired range of properties including relatively high strength in relation to thickness, suitability for different manufacturing processes, flexibility, and printability. The particular characteristics of interest may be established by the composition of the material used to make the film and its processing. Specifically, the film has a polymeric material base, which is ordinarily a thermoplastic, such as polyethylene, polypropylene, homopolymers and/or co-polymers thereof and/or any combination thereof, and one or more additives designed to adjust, modify or enhance the characteristics of the base material. For example, additives may be employed to change the color of the base polymer, increase its flexibility, make it printable, and/or other features of interest. In addition, certain characteristics may be imparted to the film during the processing. For example, the composition may be stretched in a certain manner and/or different directions to impart different structural characteristics. It may also be subjected to selectable heating and cooling regimens to impart desired structural and non-structural characteristics. Further, it may be surface modified to enhance or diminish printability, glossiness, bondability and the like.

Polymeric film products are ordinarily sold commercially by their original manufacturers by weight rather than by volume or coverage area. Their customers wish to pay as little as possible to obtain films having satisfactory characteristics with a thickness that is as minimal as possible but with the largest coverage area possible. A goal of the film manufacturers then is to maintain, improve and expand film characteristics while keeping the weight, and therefore the price, of the film as low as possible. These goals are generally opposed to one another, particularly when additives are required to produce certain film characteristics and those additives are heavier than the base material of the film.

As an example of these competing goals, an end user may wish to have a film that is relatively thin, perhaps on the order of 10 mils or less and that is white. In order to make a white polymer-based film, the film manufacturer must do something to the base material. The standard practice is to add an additive, such as a whitening additive including, but not limited to, titanium dioxide or calcium carbonate, to the base material prior to processing. Such additives ensure suitable film coloring, but they are denser than the base material and therefore drive up the film's density and the cost per weight of the finished product. Other additives may cause similar problems. It is therefore a desirable goal to create a film having desired characteristics without substantially increasing its density and, ideally, to even reduce its density. In general, it is to be noted that the base polymer materials ordinarily used to make polymer-based films have a density value of about 0.9 g/cc. Additives often drive that density up to about 1.2 g/cc or more.

There are some commercially available polymeric films having sufficient structural and other characteristics for certain cavitated and foamed film applications and that are also of relatively low density, or at least they maintain the density of the base material. These types of films may be used as decorative ribbon or in the food packaging industry, for example. The process of density reduction results in reduced structural characteristics, undesirable surface features, or a combination of the two. In one process to reduce film density, the base mixture is foamed, either with a foam-inducing additive or by whipping air into the material while molten. This foaming reduces film density but also reduces its strength and often imparts an undesirable mottling to the surface—a feature that makes printing on the film difficult. In another process, an additive with varied surface features is added to the composition in a cavitation during film orientation such that the additive creates pockets in the finished film. This process is better for maintaining structural integrity, but it too imparts less than an ideal surface characteristic.

Therefore, what is needed is a polymeric film or films having a suitable range of desired structural and non-structural characteristics at a density lower than has heretofore been possible with existing polymeric films. What is also needed is a related method for fabricating such an improved polymeric film.

### SUMMARY OF THE INVENTION

It is an object of the present invention to provide a polymeric film or films having a suitable range of desired structural and non-structural characteristics at a density lower than has heretofore been possible with existing polymeric films. It is also an object of the present invention to provide a method for fabricating such an improved polymeric film.

These and other objectives are achieved in the present invention, which is a microvoided film comprising a structural material and a microvoid forming additive. The composition may also include one or more other additives including, but not limited to, materials suitable for making the film of a specific color, printable, glossy and/or to have certain desirable structural attributes. The structural material is preferably a polyolefin, such as polyethylene, polypropylene, homopolymers and/or co-polymers thereof, and/or a combination thereof. The structural material may be formulated and processed to exhibit relatively high tensile strength with minimal shrinkage. The microvoid forming additive is one that provides for substantially uniform disbursement throughout the structural material. The microvoid forming additive may be a β-nucleating agent. As an example, a product identified as MPM 1112 available from Mayzo, Incorporated of Norcross, Ga., has been found to be suitable as such an additive. Specifically, processing of a composition including this additive in accordance with the steps described herein appears to cause an increase in β crystallization of the polypropylene. This, in turn, results in the creation of microvoids in the composition including the structural layer. The creation of microvoids in the resultant film is of lower or reduced density in comparison to the density of the film without such microvoid creation, while maintaining sufficient structural characteristics. This composition does not diminish the appearance and quality of the surface of the film such as for printing, for example.

The process of the present invention used to take advantage of the noted characteristics of the microvoid forming additive includes the step of “cold drawing” the film during the stretching process to ensure that the β crystallization transition occurs. This cold drawing generates microvoiding in the structural material and the formation of the microvoids causes the film to turn white. As a result, it is possible to reduce the amount of color pigment additive, such as titanium oxide or calcium carbonate, which would otherwise be required to make the end product film suitably white. In some applications, the whitening generated is sufficient to eliminate a whitening pigment additive altogether. The ability to reduce the amount of such additives, which are ordinarily denser than the structural material, aids in reducing the film product's final density.

The combination of use of the noted microvoid forming additive and the processing steps described herein result in a microvoided reduced density film product of substantially reduced density without a substantial loss of structural properties. Further, the combination reduces or eliminates the need to add whitening coloring pigment if that is of interest. These two advantages yield a product that is less expensive to make and therefore less expensive to consumers. Since there is minimal loss of structural properties, including tensile strength and transverse strength, and even some improvement in stiffness, the new film may be employed for any application that prior heavier films were used including, but not limited to, printable labels, tapes, coaxial cable films, tags and the like. Moreover, it has been observed in samples of the film that the surface has little to no pock marking, which is a substantial advantage over the prior foamed and cavitated film products. These features are available in the film of the present invention with little adjustment required to existing product processing equipment and steps. These advantages of the film with microvoid forming additive were surprising and unexpected based on prior experiences with void creating techniques. Moreover, the ability to use the composition in a wide range of applications as a monolayer and/or multilayer film was also surprising and unexpected. Further, it was unexpected to discover that combining the microvoid forming additive and a printability additive with the base component of the structural material would produce a single layer or multilayer film that maintained structural integrity, desired opacity, reduced density and effective printability. Initial contemplation of such a combination resulted in a concern that at least one component would have an adverse impact on a desired characteristic produced by another component. Sample films described herein including that combination of microvoid forming additive and printability additive with the structural material exhibited a contrary finding. Moreover, the combination was synergistic in that desired printability was achieved using lesser amounts of printability additive than was originally thought to be required.

The microvoid forming additive employed to produce a multilayer film results in a film having an overall density less than that of conventional film products. The microvoid forming additive may be included in one or more layers of the multilayer film. When it is desirable to produce a film with printability characteristics, the microvoid forming additive may be used in combination with a print additive to enhance the effect of the print additive without the need to add as much print additive as required to provide the necessary print quality. For example, printable films may require as much as 22% by weight of the print additive to achieve suitable print quality in a single-layer film, and for a multilayer film it may be as much as 15% by weight. However, that level of print additive necessary may be reduced substantially when the microvoid forming additive is included in the mixture for any layer including the print additive. In one example, the print additive need only be about 3% of the total weight of the film, and the total density of the film for a film that is less than five mils thick can be reduced to less than about 0.8 g/cc without sacrificing structural integrity or printability. For films that are greater than five mils thick, the density can be reduced to less than about 0.7 g/cc.

The details of one or more examples related to the invention are set forth in the accompanying drawing and the description below. Other features, objects, and advantages of the invention will be apparent from the description and accompanying drawing.

### BRIEF DESCRIPTION OF THE DRAWINGS

FIG. 1 is a simplified diagrammatic view of a first film processing system of the present invention to fabricate a single-layer microvoided film of the present invention.

FIG. 2 is a first table showing selected characteristics of an existing monolayer polymeric film identified as PR White with a whitening pigment but without a microvoid forming additive for consideration in comparison to examples of the microvoided film of the present invention.

FIG. 3 is a second table showing selected characteristics of a first example of the microvoided film of the present invention identified as S-554 for consideration in comparison to the PR White film of FIG. 2.

FIG. 4 is a third table showing selected characteristics of a second example of the microvoided film of the present invention identified as S-555 for consideration in comparison to the PR White film of FIG. 2.

FIG. 5 is a fourth table showing selected characteristics of a third example of the microvoided film of the present invention identified as S-556 for consideration in comparison to the PR White film of FIG. 2.

FIG. 6 is a simplified cross-sectional view of an example three-layer film of the present invention.

FIG. 7 is a simplified diagrammatic view of a second film processing system of the present invention to fabricate a three-layer microvoided film of the present invention.

### DETAILED DESCRIPTION OF THE PREFERRED EMBODIMENTS

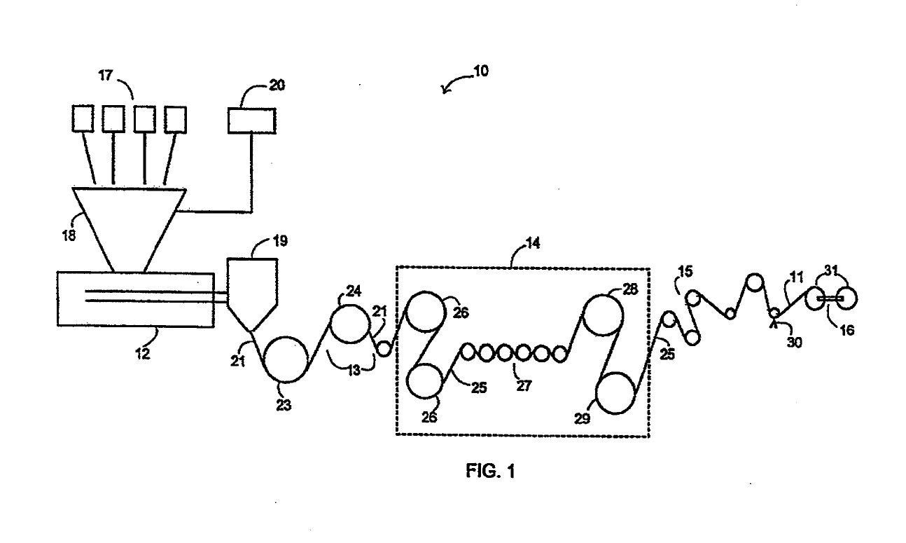

FIG. 1 shows a simplified diagrammatic view of a film fabrication system 10 used in the novel fabrication process of the present invention to create a novel microvoided (reduced density) film stock 11 having reduced density while maintaining structural integrity and the capability to be used in a wide range of applications. Primary components of the system 10 include an extruder 12, a roll unit 13, a film-orientation unit 14, a corona treatment unit 15, and an end-product winder 16. The extruder 12 is used to combine a primary structural base material, preferably a polypropylene homopolymer or a polypropylene copolymer, with a microvoid forming additive, and optionally one or more other additives selected to establish in the final film product suitable characteristics of interest. The structural base material may be nucleated or non-nucleated. A high impact polymeric material, such as Ti-4015 high impact polypropylene-polyethylene copolymer available from Sunoco, Inc. of Philadelphia, Pa., has been found suitable as the structural base material of the present invention. The microvoid forming additive may be a β-nucleating agent. As an example, a product identified as MPM 1112 available from Mayzo, Incorporated of Norcross, Ga., has been found to be a suitable microvoid forming additive. Secondary additives include, for example but not intending to be limited thereto, a pigment, such as a whitening pigment, and a printable material, preferably ethyl-vinyl-acetate (EVA) or ethyl-methacrylate (EMA) in a carrier, which carrier may be polyethylene. Suitable materials and components for the structural material and optional additives are further described in U.S. Pat. No. 6,136,439 entitled “Monolayer Polymeric Film And Method Of Fabrication” issued on Oct. 24, 2000, and U.S. Pat. No. 6,703,447 entitled “High Bi-directional Strength Monolayer Polymeric Film And Method Of Fabrication” issued Mar. 9, 2004. Both patents are in the name of the inventor of the present invention. The entire contents of both referenced patents are incorporated herein by reference. The combination of the microvoid forming additive and the printable material as additives result in a surprising end product film that is reduced in density with superior ink retention for solvent, water and the most difficult UV ink systems. Further, the inclusion of the microvoid forming additive enables the manufacturer to maintain sufficient printability while lowering the amount of the printability additive required to maintain that film printability. Printable material additives found to be compatible include EVA and EMA, with EMA being more preferable in some instances.

The materials may be in pellet or other suitable form, and may include one or more supplemental components delivered via chutes of a component feeder 17 into a mix hopper 18. All of the components are then transferred from the hopper 18 into the extruder 12 for mixing at a selected temperature prior to transfer to a die 19. The extruder 12 and the die 19 can be of any type known to those skilled in the art to be suitable for mixing and extruding components of the type described herein. It is to be understood that the particular means for mixing the structural material and the additives may be selected by the film manufacturer. The combination of the structural material and any additives, such as the microvoid forming additive, is fluid-like in the extruder 12 and as that combination emerges from the die 19, so that mixing occurs. It is noted that those skilled in the art will recognize that optional functional additives may be included in the mixture dependent upon the particular application. Such functional additives may be print-enhancers, biodegradables to enable film degradation at a selectable rate anti-blocks, anti-stats, slip additives and the like. One type of functional additive to be used is clay, which may be incorporated in a homogenized way within the film, which incorporation will eliminate any problems associated with clay applied to the film surface that may flake off. Moreover, the clay additive is suitable for use with certain types of ink systems. The die 19 directs the mixed output from the extruder 12 as a monolayer film that is extrusion 21.

The extrusion 21 is transferred from the die 19 to a first casting chiller roll 23 of the roll unit 13. The extrusion 21 may be in a range of thicknesses when first reaching the roll 23, dependent upon the ultimate function of the stock 11 to be produced. For example, the extrusion 21 may be approximately, but is not limited to, 3-200 mils thick as it moves to the first casting chiller roll 23. The extrusion 21 moves from the first chiller roll 23 to a second casting chiller roll 24. Rolls 23 and 24 may be of any suitable temperature, but preferably at a minimum of about 200° F. This chilling of the extrusion 21 acts to solidify it into a film-like material. β crystallization of the extrusion 21 occurs at this stage of the process. The temperature for processing at this stage is selected to provide the most effective opportunity for β crystallization. While it has been determined that a temperature of at least 200° F. is suitable for the desired β crystallization, the invention is not limited thereto. Instead, the temperature selected must be considered based on the effectiveness of β crystallization. From the second chiller roll 24, the extrusion 21 is delivered to the film-orientation unit 14.

In the orientation unit 14, the extrusion 21 is stretched and may be oriented into a film 25 that can range in thickness from about 1-30 mils, dependent upon the desired function of the stock 11. A pre-heater pair of rollers 26 at a temperature of about 200°-270° F. warms and softens the extrusion 21 after the chill casting stage of the process. A series of stretching rollers 27 at a temperature of about 200° F. act to considerably increase the length of the film 25. That step thins the film 25 and will also create a unidirectional molecular orientation that provides increased strength and stiffness in the film 25. The “cold drawing” of the film 25 at this stage causes the previously β crystallized extrusion 21 to turn white. It also improves strength and stiffness without losing required die cutability, such as in the manufacture of labels, for example. This cold drawing stage is preferably carried out such that the stretch ratio of the film 25 is about 3-10 to 1 so that the film orientation and uniformity are satisfactory. This may be achieved by multi-staging the draw process through one or more sets of the indicated rollers. It may also be accomplished in a single-stage draw process.

In the next stage of the process, orientation heat setting and then stress-relieving or relaxing of the film 25 occurs as it is transferred to a series of heat-stabilization rollers represented by roller 28. which may be one or more rollers, that is/are at a temperature in the range of about 270° F. to about 310° F. This imparts better stiffness and flatness in the end product in that the film 25 is unstressed as it moves across a cooling roller 29 that may be at ambient temperature. The heat-set rollers have individual drive controllers between two or more individual rollers so as to control the speed of the film passing therethrough. This maintains the flow of the product through the stress relieving stage of the process.

From the orientation unit 14, the film 25 moves to the optional corona-treatment unit 15 where the film surface may be enhanced, such as for improved printability. Final processing of the film 25 may include cutting of rough film edges by a razor 30. Scrap and/or edge trim of the film 25 may be returned for re-introduction into the process and subsequent use at scrap return hopper 20. The final stock 11 is then wound onto transfer rolls 31 of the winder unit 16 for delivery to users. However, if it is desired to impart cross-wise (bi-directional) strength orientation of the film 25, it may be further stretched by applying the film 25 or stock 11 to a tenter frame and heating in an oven (not shown). Alternatively, a blown film system known by those skilled in the art of the field of the present invention may be used to provide enhanced bi-directional strength of the stock 11 as an alternative to the extrusion system shown.

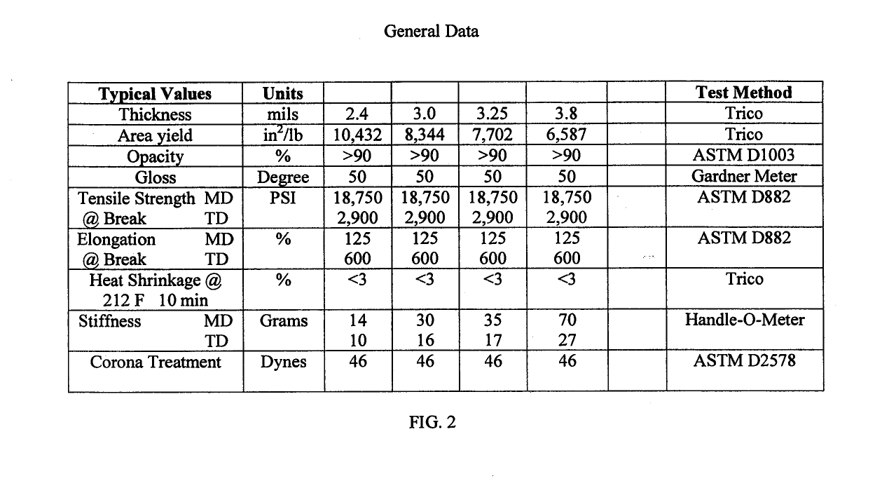

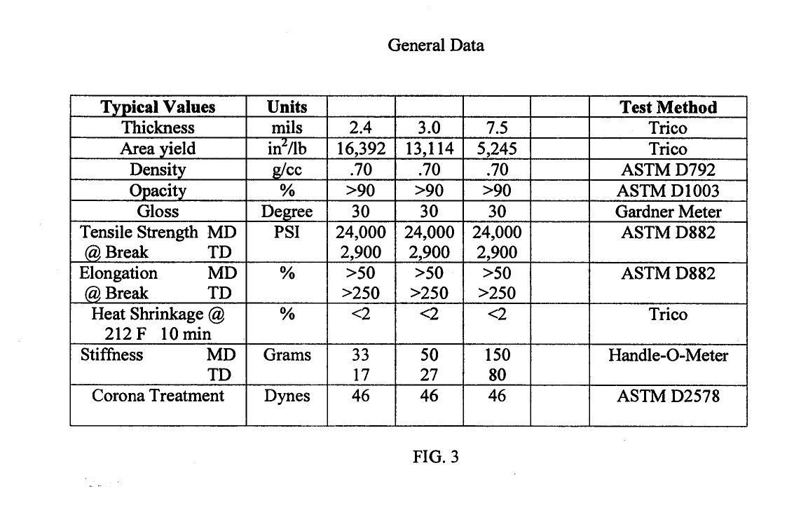

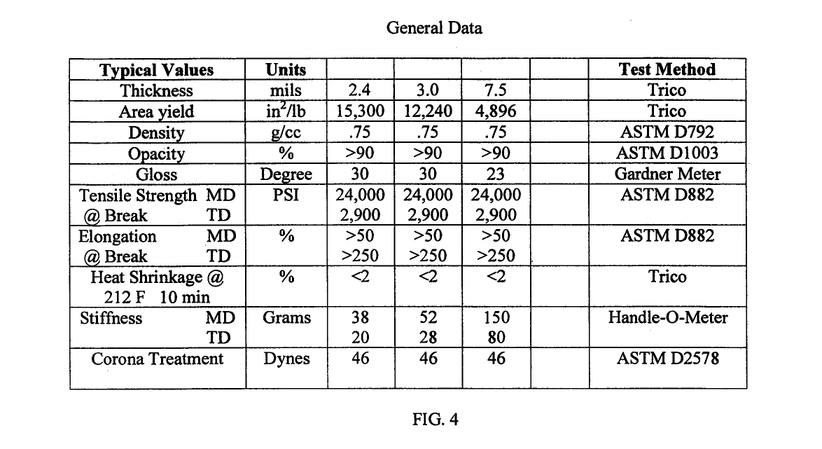

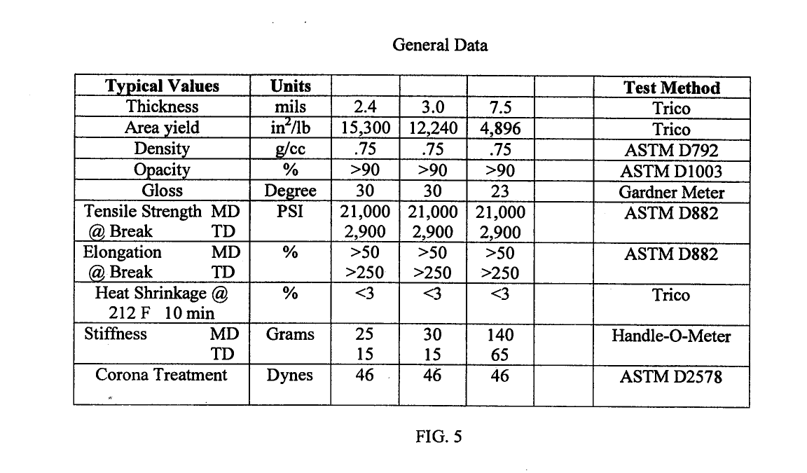

Tables of FIGS. 2-5 represent selected characteristics of four films including a prior monolayer film without microvoid forming additive identified as PR-White (FIG. 2), and three microvoided films of the present invention identified as S-554 (FIG. 3), S-555 (FIG. 4) and S-556 (FIG. 5). Each of the identified films includes the same base structural material, which is a polypropylene copolymer. The PR-White film has no microvoid forming additive but does have a whitening pigment and an additive to enhance film printability. That printability additive is EMA arranged to bloom to the surface of the film during processing such as described in referenced U.S. Pat. No. 6,703,447. The S-554 microvoided film represents a first sample of the microvoided film of the present invention. It includes the microvoid forming additive described herein. It does not include any whitening pigment nor does it include any additive to enhance film printability. The S-555 microvoided film represents a second sample of the microvoided film of the present invention. It includes the microvoid forming additive described herein and a relatively reduced amount of a whitening pigment. It does not include any additive to enhance film printability. The S-556 microvoided film represents a third sample of the microvoided film of the present invention. It includes the microvoid forming additive described herein and an additive to enhance film printability. That printability additive is EMA, but in a quantity that has been reduced by about 30%. In prior printable films including the same base structural material, it was determined that a greater amount of the printability additive, on the order of about 22% by weight, was required to produce a film of equivalent printability. The S-556 microvoided film also includes a whitening pigment. However, with the microvoid forming additive included, the amount of whitening pigment required to produce the S-556 film with desired opacity equivalent to the opacity of a film with similar structural characteristics but denser was reduced by about 60%. The present invention is not limited to such specific additive quantities. Instead, the S-556 microvoided film is simply an example of the more general concept of the present invention, a microvoided film having printability characteristics, suitable structural characteristics, and reduced density. This results in cost savings through a reduction in the amount of materials required to achieve these characteristics.

It can be seen from the tables of FIGS. 2-5 that the structural, opacity and gloss characteristics of the three microvoided film examples of the present invention are substantially the same as that for the existing non-microvoided film. However, their densities are substantially less than that of the existing non-microvoided film of FIG. 2, which is about 1.12 g/cc. It is to be noted that the incorporation of the microvoid forming additive does generate some voiding at the surface of the film. Those microscopic surface voids enable more effective print material retention at the film surface such that the amount of print additive required may be reduced for those film products requiring printability characteristics. At the same time, the appearance of the surface of the film is not altered. The S-556 microvoided film of FIG. 5 does have such an additive for optimal ink retention, and is particularly desirable in applications requiring certain film structural characteristics, such as those desired in a film applied to a flexible structure such as a plastic bottle, while also being printable, specifically when inks that are otherwise difficult to retain on a film surface are employed. It is also noted more generally that the desired die-cutability of any of the embodiments of the film of the present invention is not altered even with the microvoid forming additive is employed as described herein. The additive selected to enhance the printability of the microvoided film may be any of the ones described in the referenced patents that are compatible with the structural material used to form the film.

The microvoided film of the present invention may be suitable in a wide array of applications as a monolayer film. It may also form part of a multilayer film, examples of which are described herein, wherein the composition of the primary structural material, the microvoid forming additive, the printability additive and any other optional selected additives form a layer that is co-extruded with one or more layers of other compositions and processed as described herein or otherwise processed to produce a film product with desirable properties. The other layers also include the microvoid forming additive, although the quantity of microvoiding may be selectable from layer to layer. In a first embodiment of a multilayer arrangement of the film of the present invention, the film is a two-layer film wherein both layers include the microvoid forming additive and the printability additive. In a second embodiment of a multilayer arrangement of the film of the present invention, the film is a two-layer film wherein both layers include the microvoid forming additive and only one layer includes the printability additive, although it is an option to return scrap and/or edge trim back into the process for making the non-printable layer as well. When the scrap and/or edge trim is returned to the process of making that other layer, the hybrid composition of that layer enhances the bonding of the two layers together. In a third embodiment of a multilayer arrangement of the film of the present invention, the film is a three-layer film wherein all three layers include the microvoid forming additive and only the two outer layers include the printability additive, although it is an option to return scrap and/or edge trim back into the process for making the center layer as well. When the scrap and/or edge trim is returned to the process of making the center layer, the hybrid composition of the center layer enhances the bonding of the three layers together. It is to be noted that in any foaming process, the scrap and edge trim cannot be added back into the manufacturing process, whereas that return of scrap and/or edge trim is possible through the process of the present invention. Exercising that option for any multilayer film of the present invention can reduce overall film manufacture cost, in addition to enhancing inter-layer bonding. In a fourth embodiment of a multilayer arrangement of the film of the present invention, the film is a three-layer film wherein all three layers include the microvoid forming additive and only one of the two outer layers includes the printability additive. The same scrap and/or edge trim return option noted above is also available in regard to this embodiment of the invention as well. It can be seen that other combinations of greater numbers of layers of a multilayer film with reduced density and printability may be created with the present invention. One or more functional additives, such as a coloring pigment additive, may be added to the composition of any one or more of the layers. For example, in a three-layer embodiment of the microvoided film, the second or middle layer may include a pigmenting additive, such as a black pigment to provide 100% opacity while still maintaining a white film surface. Other types of functional additives include, but are not limited to, biodegradables, anti-statics, anti-slips and anti-blocks.

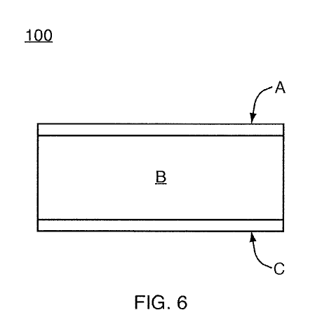

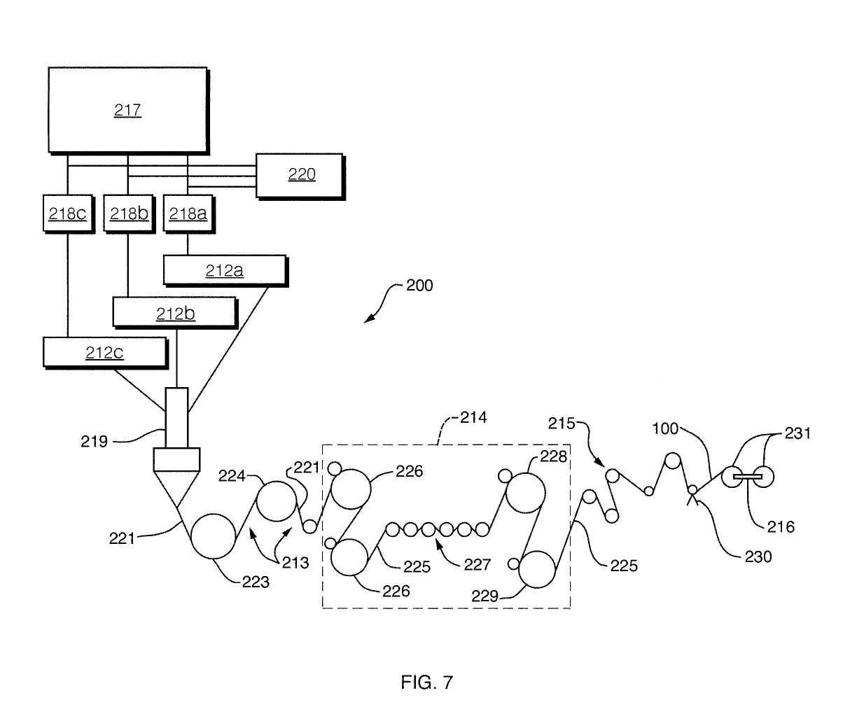

An example of a three-layer version of the multilayer film of the present invention is shown in FIG. 6. The film 100 is formed with first layer A, second layer B and third layer C. First layer A and third layer C are skin or outer layers of the film, and second layer B is an inner layer or core layer positioned between layers A and C. With reference to FIG. 7, a second embodiment of a film fabrication system 200 used to fabricate a multilayer film, such as the film 100 of FIG. 6, includes a plurality of extruders 212a-212c, a multilayer roll unit 213, a film-orientation unit 214, a corona treatment unit 215, and an end-product winder 216. The extruders 212 are used to extrude individual layers of materials including individual components selected to provide desired characteristics of each layer. A primary component of any individual layer is a structural material selected from the group consisting of polyethylenes of various densities and/or molecular weights, polypropylenes, and copolymers of polyethylene and polypropylene. Other suitable materials as the primary component may include, but are not limited to, polyesters, polyvinyl chlorides, ethylene vinyl acetate, ethylene methacrylate, high-density polyethylene, or other materials that may be of interest as a function of the particular application for the multilayer film. In general, the components may be pelletized or in any form suitable for adequate mixing and extruding. It is noted that those skilled in the art will recognize that standard additives as previously described herein may be included in the mixtures of the layers of the multilayer film dependent upon the particular application.

Components used to make the layers of the multilayer film, such as film 100, may be delivered via tubes of a component material blender 217 into individual mixing hoppers 218a-218c, one set of feeder and hopper may be used for each of the extruders 212a-212c; however, in some cases, the same feeder may be used to supply more than one extruder, or multiple feeders may supply a lesser number of extruders. For example, when two or more layers of the film are formed of the same components, such as layers A and C of film 100. The structural base material common to all of the layers in making the film 100 is Ti-4015 high impact polypropylene-polyethylene copolymer available from Sunoco, Inc. of Philadelphia, Pa., initially in a pelletized or other suitable form. All of the selected components for a particular layer are then transferred from the hopper 218a-218c into the extruder 212a-212c for mixing at a selected temperature prior to transfer to a co-extrusion block and die 219. The extruders 212a-212c and the co-extrusion block and die 219 can be of any type known to those skilled in the art to be suitable for mixing and extruding components of the type described herein. The co-extrusion block and die 219 directs the respective separately mixed outputs simultaneously from extruders 212a-212c into a single layer film or sheet that is multilayer extrusion 221.

The multilayer extrusion 221 is transferred from the co-extrusion block and die 219 to a first casting chiller roll 223 of the multilayer roll unit 213. The multilayer extrusion 221 may be in a range of thicknesses when first reaching the roll 223, dependent upon the ultimate function of the film 100 to be produced. For example, the multilayer extrusion 221 may be approximately, but is not limited to, 3-200 mils thick as it moves to the first casting chiller roll 223. The extrusion 221 moves from the first chiller roll 223 to a second casting chiller roll 224. Rolls 223 and 224 may be of any suitable temperature, but preferably about 200° F. This chilling of the extrusion 221 acts to solidify it into a film-like material. From the second chiller roll 224, the extrusion 221 is delivered to the film-orientation unit 214.

In the orientation unit 214, the extrusion 221 is stretched and may be oriented into a film or sheet 225 that can range in thickness from about 1-40 mils, but can be thinner or thicker than that range, again, dependent upon the desired function of the final multilayer film product 100. A pre-heater pair of rollers 226 at a temperature of about 200°-270° F. warms and softens the extrusion 221 after the chill casting stage of the process. A series of stretching rollers 227 at a temperature of about 200° F. act to considerably increase the length of film under process 225. That step thins the film 225 and will also create a unidirectional molecular orientation that provides increased strength and stiffness in the film 225. The “cold drawing” of the film 225 at this stage causes the previously β crystallized extrusion 221 to turn white. It also improves strength and stiffness without losing required die cutability. This cold drawing stage is preferably carried out such that the stretch ratio of the film 225 is about 3-10 to 1 so that the film orientation and uniformity are satisfactory. This may be achieved by multi-staging the draw process through one or more sets of the indicated rollers. It may also be accomplished in a single-stage draw process.

In the next stage of the process, orientation process heat setting and then stress-relieving or relaxing of the film 225 occurs as the film 225 is transferred to a heat-stabilization roller 228, which may be one or more rollers, that is/are at a temperature in the range of about 270° F. to about 295° F. This imparts better stiffness and flatness in the end product in that the film 225 is unstressed as it moves across a cooling roller 229 that may be at ambient temperature. The heat-set rollers have individual drive controllers between two or more individual rollers so as to control the speed of the film passing therethrough.

From the orientation unit 214, the film 225 moves to the optional corona-treatment unit 215 where the film surface may be enhanced, such as for improved printability. Final processing of the film under process 225 may include cutting of rough film edges by a razor 230. Scrap and/or edge trim of the film 225 may be returned for re-introduction into the process and subsequent use at scrap return hopper 220. Any such scrap and/or edge trim may be returned to one or more of mixing hoppers 218a-218c in selectable amounts. When returned to hopper 218b for the purpose of making Layer B, the composition of that scrap and/or edge trim including the base material and all additives used to make Layers A and C, renders Layer B more compatible for bonding to outer Layers A and C, thereby minimizing the possibility of interlayer delamination. The final product film 100 is then wound onto transfer rolls 231 of the winder unit 216 for delivery to users. It is to be noted that the cross-wise (bi-directional) orientation of the film 225 and/or film 100 may be further stretched and therefore increased by applying the film 225 or film 100 to a tenter frame and heating in an oven (not shown). Additionally, it is optionally preferable to heat stabilize the film 225 after biaxially stretching it. A blown film system known by those skilled in the art of the field of the present invention may be used to provide enhanced bi-directional strength of the film 100 as an alternative to the extrusion system shown. Stretching of the extrusion 221 whether through the roller process of system 10 or 200, or through blown film fabrication provides machine direction and/or transverse direction structural improvement.

It is to be noted that any of the embodiments of the film of the present invention described herein may be used in an in-mold labeling manufacturing process. In such a process, a printable film is applied to a pliable manufactured part, such as a plastic container, wherein the film is applied while the part is being shaped or molded, rather than being joined to the part after it has been manufactured to shape. The in-mold labeling part manufacturing process involves the use of temperatures on the order of 450° F., which would ordinarily destroy polymer-based films. However, the film of the present invention that has been microvoided, can withstand such manufacturing temperatures for the time periods typically experienced, possibly due to the insulative effect of the microvoids. As a result, the film of the present invention may be used directly in an in-mold labeling manufacturing process to apply the film-based label to the part in a single process. That results in a saving to the part manufacturer, and likely improved attachment of the printable film label to the manufactured part.

Returning to FIG. 6, the three-layer film 100 formed by the process of the present invention using a manufacturing system such as system 200, includes the three individual layers identified as layer A, layer B and layer C. Outer layers A and C are formed of a mixture including the Ti-4015 high impact copolymer base at about 76% by weight of the mixture, about 4% by weight of a whitening pigment, such as titanium oxide, calcium or a mixture of the two, about 18% by weight of a print additive, such as EMA, and about 2% by weight of the microvoid forming additive, such as MPM 1112 from Mayzo. Calcium has been found to be useful in further enabling density reduction. Layers A and C may be formed by adding the four identified components to hoppers 218a and 218c, for example, and extruding them through extruders 212a and 212c, respectively, for example.

Inner layer (which may otherwise be referred to as film core) B is formed of a mixture including the same copolymer base material used in the formation of layers A and C, but at a different proportion and with different additives. Specifically, layer B is formed of a mixture including the copolymer base at about 93% by weight of the mixture, about 4% by weight of the whitening pigment and about 3% by weight of the microvoid forming additive. Layer B may be formed by adding the identified components to hopper 218b, for example, and extruding it through extruder 212b for example. Layers A, B and C are separately mixed and extruded to maintain their independent characteristics. They are then simultaneously layered one on top of one another and die cast through the co-extrusion block and die 219. Optionally, the materials for layers A and C may be mixed in a common mixer and then transferred separately to extruders 212a and 212c, respectively.

The extrudates from extruders 212a and 212c are arranged such that they are substantially of equivalent thickness, whereas the extrudate from extruder 212b is arranged to be thicker than the thickness of layers A and C, individually and in total. The thicknesses of the respective extrudates are selected so that layer B of the finished film 100 comprises about 80% of the total thickness of the film 100, while layers A and C each comprise about 10% of the total thickness of the film 100.

The co-extruded layers A, B and C may then be processed through system 200 as described. The resultant film 100 that has been fabricated with the components indicated in the proportions stated has a density of about 0.68 g/cc. The components in the film 100 include about 89.6% by weight of the film 100 of the base copolymer, about 4% by weight of the whitening pigment, about 3.6% by weight of the print additive and about 2.8% of the microvoid forming additive. Whereas prior printable films made under similar process conditions required about 22% by weight of the film comprising the print additive in order to get sufficient printability characteristics of the film, the film 100 made as indicated with layers A, B and C requires only about 3.6% by weight of the print additive while still maintaining sufficient printability characteristics. That appears to be as a result of the formation of voids or indentations at the surface of the outer layers A and C, wherein the print ink may be retained therein and encouraged to remain sufficiently adhered thereto by the print additive, which print additive blooms into those voids and the surfaces of the outer layers. At the same time, the reduced need for print additive in the entirety of the film 100 resulted in a reduction in the overall density of the film 100. Moreover, the reduction in the amount of print additive required to sustain suitable printability permits the manufacturer to use more of the base copolymer in the mixture, thereby ensuring that the structural characteristics of the film 100 are better than when higher levels of additives are required in the mixture. For example, it is useful to have the multilayer film that is formed with the base material comprising about 90% or more by weight of the film. It is to be understood that the film 100 may be fabricated with only one of the outer layers having the print additive, for those films where printability is only needed on one surface of the film. Additionally, the microvoid forming additive may be added to fewer than all three layers. For example, the microvoid forming additive may be added to the mixture for only that layer or those layers for which printability is a desired characteristic as it enhances printability without increasing the film's density.

Those skilled in the art will see that a variety of compositions may be employed to produce a variety of combinations of layers having varied structural, reduced density and printability characteristics. Further, other additives may be included in the mixtures for one or more of the layers dependent upon particular characteristics desired. For example, a blackening additive may be used with or instead of the whitening pigment. The blackening additive may be carbon black or iron oxide black. The use of iron oxide black as an additive will produce a film having magnetic characteristics if that is of interest. Clay may also be used as an additive. The proportions of the additives selected may be varied provided the amount of base material in the mixture is sufficient to ensure that the film has desired minimum structural characteristics. A multilayer film such as film 100 of FIG. 6 should comprise about 90% by weight or more of the base material. It is also to be noted that the number of layers of the film and the number of extruders used to make the layers of the film can be varied. In addition, the thicknesses of the individual layers of the film may be varied.

While the example microvoided films described herein are representative of the invention, they are in no way are intended to be limiting of the principal concept of the invention. All equivalents are deemed to fall within the scope of this description of the invention as described by the following claims.

What is claimed is:

1. A film comprising:
a. a composition including a polymeric material and a printability additive including ethyl-vinyl-acetate or ethyl-methacrylate selected to bloom to a surface of the film during film formation processing; and
b. a microvoid forming additive mixed with the composition, wherein the microvoid forming additive is selected to generate microvoids in the polymeric material when forming the film sufficient to reduce the density of the polymeric material.

2. The film of claim 1 wherein the microvoid forming additive is selected to generate crystallization of the polymeric material.

3. The film of claim 2 wherein the polymeric material is polypropylene.

4. The film of claim 1 wherein the microvoid forming additive is mixed with the composition in sufficient quantity to render the film opaque.

5. The film of claim 1 wherein the composition includes a functional additive.

6. The film of claim 5 wherein the functional additive is a whitening additive.

7. The film of claim 1 wherein the density of the polymeric material is about 1.12 g/cc and the quantity of microvoid forming additive added to the composition is sufficient to reduce the density of the film to about 0.75 g/cc.

8. A film comprising:
a. a first layer; and
b. a second layer, wherein the first layer and the second layer include a composition including a polymeric material and a microvoid forming additive selected to generate microvoids in the polymeric material sufficient to reduce the density of the polymeric material, and wherein at least one of the first layer and the second layer includes a printability additive including ethyl-vinyl-acetate or ethyl-methacrylate selected to bloom to a surface of the film during film formation processing.

9. The film of claim 8 further comprising a third layer, wherein the third layer includes the polymeric material and the microvoid forming additive.

10. The film of claim 9 wherein the first layer and the third layer are sandwiched around the second layer, and wherein at least one of the first layer and the third layer includes the printability additive.

11. The film of claim 10 wherein the second layer includes a functional additive.

12. The film of claim 11 wherein the functional additive is a black pigment additive.

13. The film of claim 8 wherein the polymeric material is polypropylene.

14. A method of making a reduced density multilayer printable film comprising the steps of:
a. mixing a first mixture including a polymeric base material, a print additive and a microvoid forming additive;
b. mixing a second mixture including the polymeric base material and the microvoid forming additive;
c. co-extruding a first layer of the first mixture, a second layer of the second mixture and a third layer of the first mixture to form a co-extrudate of three layers;
d. cold drawing the co-extrudate to generate microvoids therein;
e. heating the co-extrudate sufficiently to cause the print additive to bloom to outer surfaces of the first layer and the third layer; and
f. stretching the co-extrude to create the reduced density multilayer printable film.

15. The method of claim 14 wherein the film is stretched to a thickness and wherein the second layer of the co-extrudate is co-extruded to form about 80% of the thickness of the film.

16. The method of claim 15 wherein the first layer and the second layer of the co-extrudate are co-extruded to each form about 10% of the thickness of the film.

17. The method of claim 14 wherein the first mixture includes about 76% by weight of the polymeric base material, about 18% by weight of the print additive and about 2% by weight of the microvoid forming additive, and wherein the second mixture includes about 93% by weight of the polymeric base material and about 3% by weight of the microvoid forming additive.

18. The method of claim 17 wherein the polymeric base material is a copolymer of polyethylene and polypropylene.

19. The method of claim 18 wherein the print additive is EMA.

20. The method of claim 14 further comprising the step of trimming the film after the stretching step and returning the trim to one or more of the first mixture and the second mixture.

21. A reduced density multilayer printable film comprising:
a. a first layer formed of a first mixture including a polymeric base material, a print additive and a microvoid forming additive;
b. a second layer formed of a second mixture including the polymeric base material and the microvoid forming additive; and
c. a third layer formed of the first mixture, wherein the second layer is positioned between the first layer and the third layer, wherein the first, second and third layers include microvoids, wherein the first and third layers include the print additive bloomed to exterior surfaces thereof, and wherein the density of the multilayer printable film is less than about 0.7 g/cc.

22. The film of claim 21 wherein the polymeric base material is about 90% by weight of the film, the print additive is less than 4% by weight of the film and the microvoid forming additive is less than 3% by weight of the film.

23. The film of claim 22 wherein the polymeric base material is a copolymer of polyethylene and polypropylene.

24. A method of making a labeled part in an in-mold labeling process comprising the steps of:
a. inserting a reduced density film into an in-mold labeling mold;
b. inserting sufficient material to manufacture the labeled part; and
c. processing the manufacture of the labeled part with the reduced density multilayer film in the in-mold labeling mold.

25. The method of claim 24 wherein the reduced density film is a printable film.

26. The method of claim 25 wherein the printable film is a multilayer film.

27. The method of claim 26 wherein the multilayer film is a three-layer film comprising:
a. a first layer formed of a first mixture including a polymeric base material, a print additive and a microvoid forming additive;
b. a second layer formed of a second mixture including the polymeric base material and the microvoid forming additive; and
c. a third layer formed of the first mixture,
wherein the second layer is positioned between the first layer and the third layer, wherein the first, second and third layers include microvoids, wherein the first and third layers include the print additive bloomed to exterior surfaces thereof, and wherein the density of the multilayer printable film is less than about 0.7 g/cc.
